(19) United States
(12) Patent Application Publication
(10) Pub. No.: US 2019/0348644 A1
(43) Pub. Date: Nov. 14, 2019

(54) HIGH POWER BATTERY AND BATTERY CASE

(71) Applicant: SHOWA DENKO PACKAGING CO., LTD., Kanagawa (JP)

(72) Inventor: Koji MINAMITANI, Kanagawa (JP)

(73) Assignee: SHOWA DENKO PACKAGING CO., LTD., Kanagawa (JP)

(21) Appl. No.: 16/461,454

(22) PCT Filed: Nov. 7, 2017
(86) PCT No.: PCT/JP2017/040118

§ 371 Date: May 16, 2019

(30) Foreign Application Priority Data
Nov. 21, 2016 (JP) 2016-225813

(51) Int. Cl. H01M 2/02; H01M 10/0525

(52) U.S. Cl. CPC H01M 2/0272; H01M 10/0525; H01M 2/0287

(57) ABSTRACT

A high power battery 1 is provided with a case having two battery element chambers 51, 52 formed by being surrounded by a heat-sealed portion formed by arranging two laminate materials in which a heat resistant resin layer 13 is laminated on one surface of a metal foil 11 and a heat fusible resin layer 15 is laminated on the other surface of the metal foil 11 with the heat fusible resin layers 15 facing inward and fusing the heat fusible resin layers 15, and two battery elements 61, 62 accommodated in respective battery element chambers 51, 52 of the case. One of the laminate materials 22 of the case is provided with inner metal exposed portions 25, 26 through which a part of the metal foil 11 is exposed in respective battery element chambers, and two battery elements 61, 62 are connected in series via the inner metal exposed portion 25, 26 of one of the laminate materials 22 in the battery element chamber 51, 52 and a metal foil 11 of the one of the laminate materials.

### TECHNICAL FIELD

The present invention relates to a high power battery used as a storage battery (e.g., a lithium ion secondary battery), a condenser (or a capacitor), an all solid state battery, and the like, used for an electric tool, an automobile, a regenerative energy recovery, a digital camera, a powered automobile model, and the like. It is also relates to a battery case used for a high power battery.

### BACKGROUND ART

In cases where high output is required in a battery for the above-described applications, it is addressed by connecting a plurality of batteries in series. In recent years, in response to the demand for miniaturization and thinning of batteries, an assembled battery has been proposed in which thin-type batteries each having a case made of a laminate material are connected in series (see Patent Documents 1 and 2).

Patent Document 1 describes an assembled battery in which a plurality of general batteries other than a bipolar battery is connected in series by tab tears. Patent Document 2 describes an assembled battery in which a plurality of stack-type bipolar batteries in which a metal foil of a laminate sheet constituting a case is exposed to the inside and outside of the case to form a conductive part is connected in series by stacking them while reversing the positions of the positive electrode and the negative electrode.

### PRIOR ART DOCUMENT

### Patent Document

Patent Document 1: Japanese Unexamined Patent Application Publication No. 2005-216631 (FIG. 1)
Patent Document 2: Japanese Unexamined Patent Application Publication No. 2005-276486 (FIG. 6)

### SUMMARY OF THE INVENTION

### Problems to be Solved by the Invention

In the case of the assembled battery described in Patent Document 1, it is configured such that respective general batteries are connected by tab leads pulled out from t respective cases, and therefore the overall size increases. In the case of the assembled battery described in Patent Document 2, no tab lead is used, and therefore no space for connection will be required. However, since a plurality of bipolar batteries is stacked, the thickness increases.

### Means for Solving the Problems

The present invention has been made in view of the above-described background art, and aims to provide a battery capable of achieving high-output while being compact and thin.

That is, the present invention has the following configurations as recited in the following Items [1] to [6].

[1] A high power battery comprising:

a case having two battery element chambers formed by being surrounded by a heat-sealed portion formed by arranging two laminate materials in which a heat resistant resin layer is laminated on one surface of a metal foil and a heat fusible resin layer is laminated on the other surface of the metal foil with the heat fusible resin layers facing inward and fusing the heat fusible resin layers; and

two battery elements accommodated in respective battery element chambers of the case,

wherein one of the laminate materials of the case is provided with inner metal exposed portions through which a part of the metal foil is exposed in the respective battery element chambers,

wherein the two battery elements are connected in series via the inner metal exposed portions of the one of the laminate materials in the respective battery element chambers and the metal foil of the one of the laminate materials, and

wherein in each of the two battery elements, a positive electrode or a negative electrode of one of the two battery elements which is not connected to the other of the two battery elements is connected to one end of a lead.

[2] A high power battery comprising:

a case having two battery element chambers formed by being surrounded by a heat-sealed portion formed by arranging two laminate materials in which a heat resistant resin layer is laminated on one surface of a metal foil and a heat fusible resin layer is laminated on the other surface of the metal foil with the heat fusible resin layers facing inward and fusing the heat fusible resin layers; and

two battery elements accommodated in respective battery element chambers of the case,

wherein in the case, one of the laminate materials is provided with inner metal exposed portions through which a part of the metal foil is exposed in the respective battery element chambers,

wherein the two battery elements are connected in series via the inner metal exposed portions of the one of the laminate materials in the respective battery element chambers and the metal foil of the one of the laminate materials,

wherein a positive electrode or a negative electrode of one of the battery elements which is not connected to the other of the battery elements is connected to one end of a lead, and the other end of the lead is pulled out of the case from between the heat fusible resin layers of the laminate materials, and

wherein a negative electrode or a positive electrode of the one of the battery elements which is not connected to the other of the battery elements is electrically connected to an inner metal exposed portion through which a part of the metal foil of the other of the laminate materials is exposed in the battery element chamber, and the other of the laminate materials is provided with an outer metal exposed portion through which a part of the metal foil is exposed outside the battery element chamber.

[3] A battery case comprising:

two battery element chambers formed by being surrounded by a heat-sealed portion formed by arranging two laminate materials in which a heat resistant resin layer is laminated on one surface of a metal foil and a heat fusible resin layer is laminated on the other surface of the metal foil with the heat fusible resin layers facing inward and fusing the heat fusible resin layers,

wherein one of the laminate materials of the case is provided with inner metal exposed portions through which a part of the metal foil is exposed in respective battery element chambers, and

wherein the other of the laminate materials is provided with an inner metal exposed portion through which a part of the metal foil is exposed in one of the battery element chambers and an outer metal exposed portion through which a part of the metal foil is exposed to an outer surface of the case.

[4] A high power battery comprising:

a case having three battery element chambers including first to third battery element chambers formed by being surrounded by a heat-sealed portion formed by arranging two laminate materials in which a heat resistant resin layer is laminated on one surface of a metal foil and a heat fusible resin layer is laminated on the other surface of the metal foil with the heat fusible resin layers facing inward and fusing the heat fusible resin layers; and

three battery elements accommodated in respective battery element chambers of the case,

wherein in the case, the two laminate materials are each provided with an inner metal exposed portion through which a part of a metal foil is exposed in the second battery element chamber, one of the laminate materials is provided with an inner exposed portion through which a part of the metal foil is exposed in the first battery element chamber, and the other of the laminate materials is provided with an inner exposed portion through which a part of the metal foil is exposed in the third battery element chamber,

wherein the first battery element accommodated in the first battery element chamber and the second battery element accommodated in the second battery element chamber are connected in series via the inner metal exposed portions of the one of the laminate materials and the metal foil thereof, and the second battery element accommodated in the second battery element chamber and the third battery element accommodated in the third battery element chamber are connected in series via the inner metal exposed portions of the other of the laminate materials and the metal foil thereof, and

wherein a positive electrode or a negative electrode of the first battery element which is not connected to the second battery element is connected to one end of a lead, and a negative electrode or a positive electrode of the third battery element which is not connected to the second battery element is connected to one end of a lead.

[5] A battery case comprising:

three battery element chambers including first to third battery element chambers formed by being surrounded by a heat-sealed portion formed by arranging two laminate materials in which a heat resistant resin layer is laminated on one surface of a metal foil and a heat fusible resin layer is laminated on the other surface of the metal foil with the heat fusible resin layers facing inward and fusing the heat fusible resin layers,

wherein in the second battery element chamber, the two laminate materials are each provided with an inner metal exposed portion through which a part of the metal foil is exposed,

wherein in the first battery element chamber, one of the laminate materials is provided with an inner metal exposed portion through which a part of the metal foil is exposed, and

wherein in the third battery element chamber, the other of the laminate materials is provided with an inner metal exposed portion through which a part of the metal foil is exposed.

[6] A high power battery comprising:

a case having four battery element chambers including first to fourth battery element chambers formed by being surrounded by a heat-sealed portion formed by arranging two laminate materials in which a heat resistant resin layer is laminated on one surface of a metal foil and a heat fusible resin layer is laminated on the other surface of the metal foil with the heat fusible resin layers facing inward and fusing the heat fusible resin layers; and

four battery elements accommodated in respective battery element chambers of the case,

wherein in the case, one of the laminate materials provided with an inner metal exposed portion through which apart of the metal foil is exposed in the first battery element chamber and an inner metal exposed portion through which a part of the metal foil is exposed in the second battery element chamber, and the other of the laminate materials is provided with an inner metal exposed portion through which a part of the metal foil is exposed in the third battery element chamber and an inner metal exposed portion through which a part of the metal foil is exposed in the fourth battery element chamber,

wherein a first battery element accommodated in the first battery element chamber and a second battery element accommodated in the second battery element chamber are connected in series via the inner metal exposed portions of the one of the laminate materials and the metal foil thereof,

wherein a third battery element accommodated in the third battery element chamber and a fourth battery element accommodated in the fourth battery element chamber are connected in series via the inner metal exposed portions of the other of the laminate material and the metal foil thereof,

wherein a lead is arranged between the first laminate materials and the second laminate material of the heat-sealed portion between the second battery element chamber and the third battery element chamber, one end of the lead is connected to a negative electrode or a positive electrode of the second battery element in the second battery element chamber which is not connected to the first battery element, the other end of the lead is connected to a negative electrode or a positive electrode of the third battery element in the third battery element chamber which is not connected to the fourth battery element, so that the third battery element and the third battery element are connected in series via the lead, and

wherein a positive electrode or a negative electrode of the first battery element which is not connected to second battery element is connected to one end of a lead, and a negative electrode or a positive electrode of the fourth battery element which is not connected to the third battery element is connected to one end of a lead.

### Effects of the Invention

In the high power battery as described in the aforementioned Item [1], the case is provided with two battery element chambers, and the battery elements accommodated in respective battery element chambers are connected in series via a metal foil of a laminate material constituting a case within one case. Therefore, as compared with the case in which batteries in which one battery element is accommodated in one case are connected outside a case, it is possible to perform connections with less space. In addition, the case is thin type in which battery element chambers are formed by arranging two laminate materials so as to face each other. Therefore, a high power battery can be reduced in size and thickness. Moreover, since it is thin, it is high in heat dissipation.

In the high power battery as described in the aforementioned Item [2], one of the positive electrode terminal and the negative electrode terminal uses the metal exposed portion provided on the outer surface of the case and does not use a lead. Therefore, In addition to the miniaturization effect by series connection within the case as described in the aforementioned Item [1], further miniaturization can be achieved. Moreover, since it thin, it is high in heat dissipation.

In the battery case described in the aforementioned Item [3], battery elements can be connected in series in the case as the case of the high power battery described in the aforementioned Item [2]

In the high power battery as described in the aforementioned Item [4], the case is provided with three battery element chambers, and the battery elements accommodated in respective battery element chambers are connected in series via the metal foil of the laminate material constituting the case within one case. Therefore, as compared with the case in which batteries in which one battery element is accommodated in one case are connected outside a case, it s possible to perform connections with less space. In addition, the case is a thin type in which battery element chambers are formed by arranging two laminate materials so as to face each other. Therefore, the high power battery can be reduced in size and thickness. Moreover, since it is thin, it is high in heat dissipation.

In the battery case as described in the aforementioned Item [5], as the case of the high power battery described in the aforementioned Item [4], the battery elements can be connected in series within the case.

In the high power battery as described in the aforementioned Item [6], the case is provided with four battery element chambers, and the battery elements accommodated in respective battery element chambers are connected in series via the metal foil of the laminate material constituting the case and the lead within one case. Therefore, as compared with the case in which batteries in which one battery element is accommodated in one case are connected outside a case, possible to perform connections with less space. In addition, the case is a thin type in which battery element chambers are formed by arranging two laminate materials so as to face each other. Therefore, the high power battery can be reduced in size and thickness. Moreover, since it is thin, it is high in heat dissipation.

### BRIEF DESCRIPTION OF THE DRAWINGS

FIG. 1 is a cross-sectional view of laminate materials constituting a case of a high power battery of the present invention.

FIG. 2A is a plan view of a high power battery in which two battery elements are connected in series.

FIG. 2B is a cross-sectional view taken along the line 2B-2B of FIG. 2A.

FIG. 3 is a cross-sectional view of another high power battery in which two battery elements are connected in series.

FIG. 4A is a plan view of a high power battery in which three battery elements are connected in series.

FIG. 4B is a cross-sectional view taken along the line 4B-4B of FIG. 4A.

FIG. 5A is a plan view of a high power battery in which four battery elements are connected in series.

FIG. 5B is a cross-sectional view taken along the line 5B-5B of FIG. 5A.

### EMBODIMENT FOR CARRYING OUT THE INVENTION

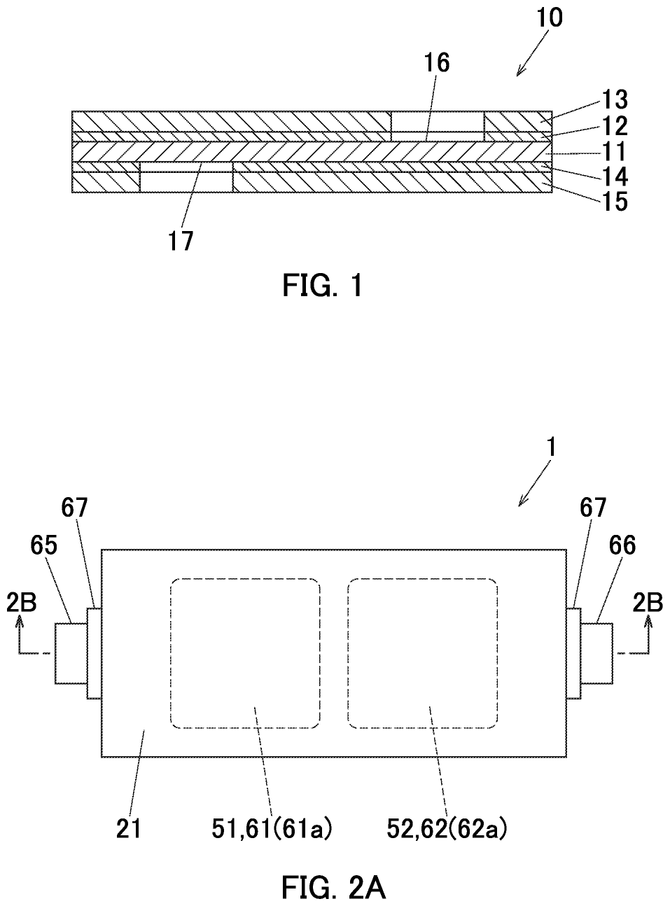

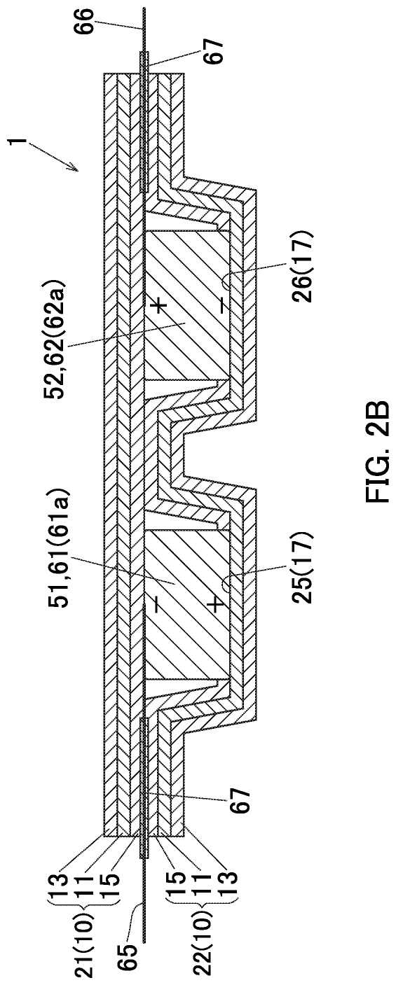

FIG. 1 shows a laminate structure of laminate materials which is a material of a battery case of the present invention, and FIG. 2A to FIG. 5B show three types of high-output batteries.

### [Laminate Material]

As shown in FIG. 1, in the laminate material 10, a heat resistant resin layer 13 serving as an outer layer of a case is laminated on one surface of a metal foil 11 via a first adhesive layer 12, a heat fusible resin layer 15 serving as an inner layer of the case is laminated on the other surface of the metal foil layer 11 via a second adhesive layer 14, and resin layers are laminated on both surfaces of the metal foil 11.

For the laminate material 10 of the laminate structure described above, metal exposed portions are formed according to the form of a high power battery to be described later. That is, on the surface of the heat resistant resin layer 13 side, a part of the heat resistant resin layer 13 and a part of the first adhesive layer 12 are not formed, so that a metal exposed portion 16 through which the metal foil 11 is exposed is formed as necessary. Further, on the surface of the heat fusible resin layer 15 side, a part of the heat fusible resin layer 15 and a part of the second adhesive layer 14 are not formed, so that at least two metal exposed portions 17 through which the metal foil 11 is exposed are formed. Note that a laminate material 10 having no metal exposed portions 16 and 17 may be used as the material of the case.

The metal exposed portions 16 and 17 can be produced by, for example, the following method.

An adhesive agent is applied to the metal foil 11 while forming an adhesive agent unapplied portion in which no adhesive agent is applied using a gravure roll having an unevenness surface to form a first adhesive layer 12, and then the metal foil 11 and a heat resistant resin layer 13 are bonded and subjected to an aging treatment. With the same method, a second adhesive layer 14 having adhesive agent unapplied portions is formed and a heat fusible resin layer 15 is bonded thereon. Then, the heat resistant resin layer 13 on the adhesive agent unapplied portion is cut along the contour of the adhesive agent unapplied portion with a laser blade, a physical blade or the like to remove the resin piece, so that a metal exposed portion 16 is formed. The metal exposed portion 17 on the heat fusible resin layer 15 side is also formed by the same method.

### (Material of Laminate Material)

It should be note that the present invention does not limit the materials of the respective layers constituting the laminate material 1, but the following are examples of preferred materials.

As the metal foil 11, an aluminum foil, a stainless steel foil, a nickel foil, a copper foil, a titanium foil, and a clad foil of these metals can be exemplified, and a plated foil plated on the aforementioned metal foil can also be exemplified. It is also preferable to form a chemical conversion coating on the aforementioned metal foil. The thickness of the metal foil 11 is preferably 7 μm to 150 μm.

As the heat resistant resin constituting the heat resistant resin layer 13, a heat resistant resin which does not melt at the heat sealing temperature when heat sealing the laminate material is used. As the heat resistant resin, it is preferable to use a thermoplastic resin having a melting point higher than the melting point of the thermoplastic resin constituting the heat fusible resin layer 15 by 10° C. or more, and it is particularly preferable to use a thermoplastic resin having a melting point higher than the melting point of the thermoplastic resin by 20° C. or more. For example, a polyamide film, a polyester film, etc., can be exemplified, and these stretched films are preferably used. Among them, in terms of formability and strength, a biaxially stretched polyamide film or a biaxially stretched polyester film, or a multilayer film containing these films is particularly preferable. Further, it is preferable to use a multilayer film in which a biaxially stretched polyamide film and a biaxially stretched polyester film are laminated. As the polyamide film, it is not particularly limited, but for example, a 6-polyamide film, a 6,6-polyamide film, and an MXD polyamide film can be exemplified. Further, as the biaxially stretched polyester film, a biaxially stretched polybutylene terephthalate (PBT) film, a biaxially stretched polyethylene terephthalate (PET) film, etc., can be exemplified. In addition, the heat resistant resin layer 13 may be formed of a single layer, or may be formed of multiple layers made of, for example, a PET film/a polyamide film. Further, the thickness is preferably within the range of 9 μm to 50 μm.

As the thermoplastic resin constituting the heat fusible resin layer 15, in terms of chemical resistance and heat sealability, the thermoplastic resin is preferably composed of polyethylene, polypropylene, an olefin based copolymer, an acid modified product thereof, and an ionomer thereof. As the olefin based copolymer, an EVA (ethylene.vinyl acetate copolymer), an EAA (ethylene.acrylic acid copolymer), and an EMAA (ethylene.methacrylic acid copolymer) can be exemplified. Further, a polyamide film (for example, 12 nylon) or a polyimide film can also be used. Further, the thickness is preferably within the range of 20 μm to 80 μm.

As the first adhesive agent 12 on the heat resistant resin layer 13 side, for example, it is preferable to use an adhesive agent containing a two-part curing type polyester-urethane based resin including a polyester resin as a main agent and a polyfunctional isocyanate compound as a curing agent, or a polyether-urethane resin. On the other hand, as the second adhesive agent 14 on the heat fusible resin layer 15 side, an adhesive agent, such as, e.g., a polyurethane based adhesive agent, an acryl based adhesive agent, an epoxy based adhesive agent, a polyolefin based adhesive agent, an elastomer based adhesive agent, and a fluorine based adhesive agent, can be exemplified.

### [High Power Battery]

FIG. 2A to FIG. 5B show four types of high-output batteries 1, 2, 3, and 4.

In the following description, members allotted by the same reference numerals indicate the same or equivalent members, and redundant explanations thereof are omitted.

### (Case)

In the case of the high-output batteries 1, 2, and 3, a first laminate material 21, 31, 41 which is a flat sheet and a second laminate material 22, 42 having recesses formed by drawing the heat fusible resin layer 15 are used as materials. The first laminate material 21, 31, 41 and the second laminate material 22, 42 are faced with the heat fusible resin layers 15 facing inward, and the heat fusible resin layers 15 around the recesses are fused, so that two battery element chambers 51, 52, and 72 or three battery element chambers 81, 82, and 83 are formed.

Also, a first laminate material 101 and a second laminate material 102, which are materials of the case of the high power battery 4, are formed such that both the first laminate material 101 and the second laminate material 102 each have two recesses in which the heat fusible resin layers 15 are recessed and a flat portion. The flat portion of the second laminate material 102 is arranged on recesses of the first laminate material 101 and the fiat portion of the first laminate material 101 is arranged on the recesses of the second laminate material 102 and the heat fusible resin layers 15 around the recesses are fused, so that four battery element chambers 111, 112, 113, and 114 are formed.

Battery elements 61, 62, 63, and 64 are accommodated in the respective battery element chambers 51, 52, 71, 72, 81, 82, 83, 111, 112, 113, and 114. Note that in the laminate materials 21, 31, 41, 22, 42, 101, and 102 shown in the figures, the adhesive layers 12 and 14 are omitted and only three layers of the metal foil 11, the heat resistant resin layer 13, and the heat fusible resin layer 15 are shown.

In the high-output batteries 1, 2, 3, and 4, the plurality of battery element chambers are referred to as, in order from the left of the figures, a first battery element chamber 51, 71, 81, 111, a second battery element chamber 52, 72, 82, 112, a third battery element chamber 83, 113, and a fourth battery element chamber 114. Further, the battery elements accommodated in these battery element chambers are referred to as a first battery element 61, a second battery element 62, a third battery element 63, and a fourth battery element 64. Further, the metal exposed portions formed in the battery element chambers 51, 71, 81, 111, 52, 72, 82, 112, 83, 113, and 114 are referred to as inner metal exposed portions 25, 26, 43, 44, 45, 46, 115, 116, 117, and 118, and the metal exposed portion formed out de the battery element chamber 51 is referred to as an outer metal exposed portion 36.

### (Battery Element)

The battery element is configured by a bare cell composed of a positive electrode, a negative electrode, and a separator arranged between the positive electrode and the negative electrode, and an electrolyte. A plurality of positive electrodes and a plurality of negative electrodes are stacked while sandwiching separators, and all the positive electrodes are joined to form a positive electrode of a bare cell, and all the negative electrodes are joined to form a negative electrode of the bare cell. Alternatively, a positive electrode, a separator, a negative electrode, and a separator are laminated in this order and rolled to form a bare cell, and the positive electrode and the negative electrode are exposed to the two opposing surfaces of the bare cell. The positive electrode is formed by laminating a positive electrode active material layer on one surface of a metal foil via a binder. In the same manner, the negative electrode is formed by laminating a negative electrode active material layer on one surface of a metal foil via a binder.

As the metal foil for the positive electrode, an aluminum foil having a thickness of 7 μm to 50 μm is preferably used. The positive electrode active material layer is formed by a mixed composition in which a salt (for example, lithium cobaltate, lithium nickelate, lithium iron phosphate, lithium manganate, etc.) is added to a binder such as PVDF (polyvinylidene difluoride), SBR (styrene butadiene rubber), CMC (carboxymethyl cellulose sodium salt, etc.), and PAN (polyacrylonitrile). The mixed composition is suitably used for a lithium ion secondary battery or the like, but it is preferable to use carbon based activated carbon as a positive electrode active material in an electric double layer capacitor or the like. The thickness of the positive electrode active material portion is preferably set to 2 μm to 300 μm. The positive electrode active material layer may further contain a conductivity enhancer, such as, e.g., a carbon fiber, a carbon black, and a CNT (carbon nanotube). As the binder layer, a layer made of PVDF, SBR, CMC, PAN, or the like can be exemplified. In order to improve the conductivity between the metal foil and the positive electrode active material layer, conductivity enhancer, such as, e.g., a carbon black and a CNT (carbon nanotube), may be further added to the binder layer.

As the metal foil for the negative electrode, a copper foil having a thickness of 7 μm to 50 μm is preferably used. However, other than the above, for example, an aluminum foil, a titanium foil, a stainless steel foil or the like can also be used. The negative electrode active material layer is formed by a mixed composition, etc., which an additive (for example, graphite, lithium titanate, Si based alloy, tin type alloy, etc.) is added to a binary, such as, e.g., PVDF, SBR, CMC, and PAN. The thickness of the negative electrode active material portion is preferably set to 1 μm to 300 μm. The negative electrode active material layer may further contain a conductivity enhancer, such as, e.g., a carbon fiber, a carbon black, and a CNT.

The binder layer is common to the positive electrode and the negative electrode, and a layer formed by PVDF, SBR, CMC, PAN, or the like, can be exemplified. In order to improve the conductivity between the metal foil and the positive and negative electrode active material layers, a conductivity enhancer, such as, e.g., a carbon black and a CNT (carbon nanotube), may be further added to the binder layer.

The separators are exemplified by a polyethylene separator, a polypropylene separator, a separator formed of a multilayer film composed of a polyethylene film and a polypropylene film, and a separator composed of a wet or dry porous film coated with a heat resistant inorganic material such as ceramics on one of the above-described resin separators. The thickness of the separator is preferably set to 5 μm to 50 μm.

As the electrolyte, it is preferable to use a mixed nonaqueous electrolyte containing at least two kinds of electrolytes selected from the group consisting of ethylene carbonate, propylene carbonate, dimethyl carbonate, ethyl methyl carbonate, diethyl carbonate, and dimethoxyethane, and a lithium salt. As the lithium salt, lithium hexafluorophosphate, lithium tetrafluoroborate, and the like, are exemplified. As the electrolyte, an electrolyte obtained by gelling the above-described mixed nonaqueous based electrolyte with PVDF, PEO (polyethylene oxide) or the like may be used.

Note that the structure of the battery element and the material of the battery element are not limited to the above.

### (First High Power Battery)

As shown in FIG. 2A and FIG. 2B, the first laminate material 21 constituting the case of the high power battery 1 is not provided with a metal exposed portion, and the second laminate material 22 having two recesses is provided with an inner metal exposed portion 25 in the first battery element chamber 51 and an inner metal exposed portion 26 in the second battery element chamber 52. The inner metal exposed portions 25 and 26 correspond to the metal exposed portion 17 formed on the surface of the heat fusible resin layer 15 side shown in FIG. 1.

In the first battery element 61 accommodated in the first battery element chamber 51, the positive electrode is in contact with the inner metal exposed portion 25 and electrically connected to the metal foil 11, and in the second battery element 62 accommodated in the second battery element chamber 52, the negative electrode is in contact with the inner metal exposed portion 26 and electrically connected to the metal foil 11. Thus, the first battery element 61 and the second battery element 62 are connected in series via the metal foil 11 of the second laminate material 22.

The negative electrode of the first battery element 61 is connected to one end of a lead 65, and the other end of the lead 65 is pulled out from between the first laminate material 21 and the second laminate material 22 to the outside of the first battery element chamber 51. The pulled-out portion is served as the negative electrode terminal of the high power battery 1. Further, the positive electrode of the second battery element 62 is connected to one end of a lead 66, and the other end of the lead 66 is pulled out from between the first laminate material 21 and the second laminate material 22 to the outside of the second battery element chamber 52. The pulled-out portion is served as the positive electrode terminal of the high power battery 1. An insulating resin film 67 is bonded to both surfaces of the middle Portion of the leads 65 and 66. The resin film 67 has an effect of enhancing the sealing performance of the battery element chambers 51, 52 by increasing the bonding force with the heat fusible resin layer 15 at the time of heat sealing.

### (Second High Power Battery)

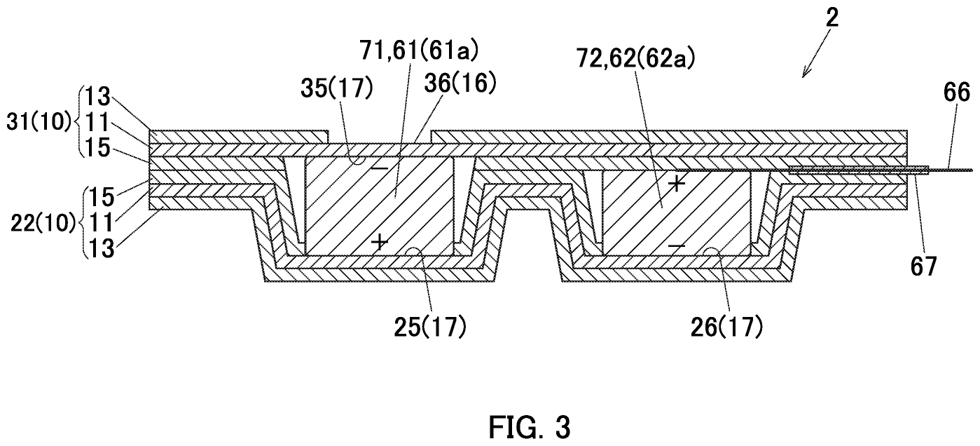

The high power battery 2 shown in FIG. 3 differs from the high power battery 1 shown in FIG. 2A and FIG. 2B in the form of the negative electrode terminal. The material of the case differs in the first laminate material 31, and the second laminate material 22 is common.

The first laminate material 31 is provided with an inner metal exposed portion 35 in the first battery element chamber 71 and an outer metal exposed portion 36 on the outer surface. The inner metal exposed portion 35 corresponds to the metal exposed portion 17 formed on the surface of the heat fusible resin layer 15 side shown in FIG. 1, and the outer metal exposed portion 36 corresponds to the metal exposed portion 16 formed on the surface on the heat resistant resin layer 13 side.

In the first battery element 61 accommodated in the first battery element chamber 71, the positive electrode is in contact with the inner metal exposed portion 25 and electrically connected to the metal foil 11, and in the second battery element 62 accommodated in the second battery element chamber 72, the negative electrode is in contact with the inner metal exposed portion 26 and electrically connected to the metal foil 11. Thus, the first battery element 61 and the second battery element 62 are connected in series via the metal foil 11 of the second laminate material 22.

On the other hand, the negative electrode of the first battery element 61 is in contact with the inner metal exposed portion 35 of the first laminate material 31 and electrically connected to the metal foil 11, and the outer metal exposed portion 36 through which the metal foil 11 is exposed to the outer surface of the case is served as a negative electrode terminal of the high power battery 2. Further, the positive electrode of the second battery element 62 is connected to one end of the lead 66, and the other end of the lead 66 is pulled out from between the first laminate material 31 and the second laminate material 22 to the outside of the second battery element chamber 72. The pulled-out portion is served as a positive electrode terminal of the high power battery 2.

The high power battery 2 is an example in which the outer metal exposed portion 36 is provided on the outer surface of the first battery element chamber 71, but in the case of the first laminate material 31, an outer metal exposed portion (negative electrode terminal) can be provided on the outer surface of the second battery element chamber 42 or on the heat-sealed portion. Further, it may be configured such that the end portion of the first laminate material 31 is extended from the heat-sealed portion to expose the heat fusible resin layer 15 and a metal exposed portion 17 is formed in the exposed heat fusible resin layer 15 to serve as a negative electrode terminal.

### (Third High Power Battery)

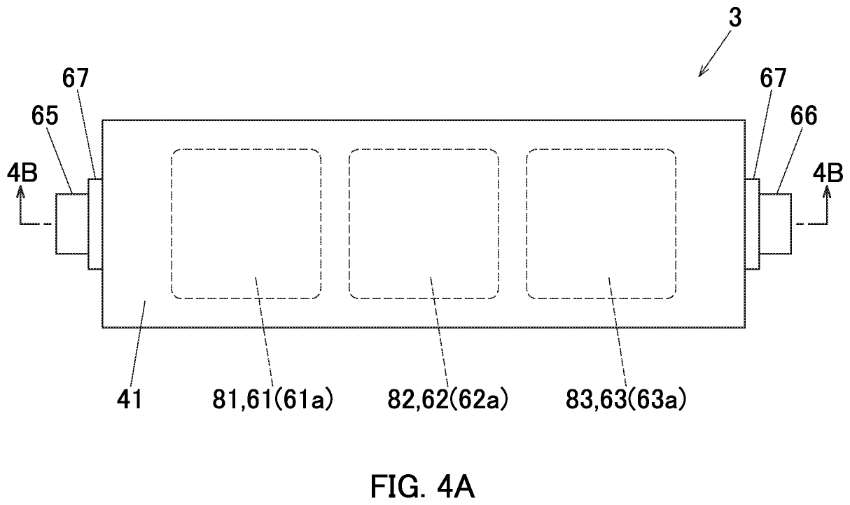

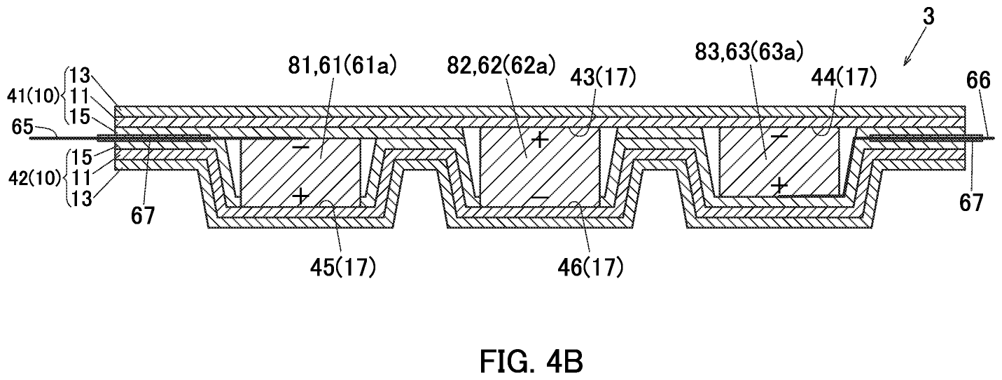

As shown in FIG. 4A and FIG. 4B, the high power battery 3 is provided with three battery element chambers 81, 82, and 83. The first laminate material 41 constituting the case provided with an inner metal exposed portion 43 in the second battery element chamber 82 and an inner metal exposed portion 44 in the third battery element chamber 83. The second laminate material 42 having recesses is provided with an inner metal exposed portion 45 in the first battery element chamber 81 and an inner metal exposed portion 46 in the second battery element chamber 82. The inner metal exposed portions 43, 44, 45, and 46 correspond to the metal exposed portion 17 formed on the surface of the heat fusible resin layer 15 side shown in FIG. 1.

In the first battery element 61 accommodated in the first battery element chamber 81, the positive electrode is in contact with the inner metal exposed portion 45 of the second laminate material 42 and electrically connected to the metal foil 11. In the second battery element 62 accommodated in the second battery element chamber 82, the negative electrode is in contact with the inner metal exposed portion 46 of the second laminate material 42 and electrically connected to the metal foil 11. The positive electrode of the second battery element 62 is in contact with the inner metal exposed portion 43 of the first laminate material 41 and electrically connected to the metal foil 11. In the third battery element 83 accommodated in the third battery element chamber 63, the negative electrode is in contact with the inner metal exposed portion 44 of the first laminate material 41 and electrically connected to the metal foil 11. Thus, the first battery element 61 and the second battery element 62 are connected in series by the metal foil 11 of the second laminate material 42, and the second battery element 62 and the third battery element 63 are connected in series by the metal foil 11 of the first laminate material 41. Thus, three battery elements 61, 62, and 63 are connected in series.

The negative electrode of the first battery element 61 positioned at one end portion of one of the three first to third battery elements 61, 62, and 63 connected in series is connected to one end of a lead 65. The other end of the lead 65 is pulled out from between the first laminate material 41 and the second laminate material 42 to the outside of the first battery element chamber 8. The pulled-out portion is served as a negative electrode terminal of the high power battery 3. Further, the positive electrode of the third battery element 63 positioned at the other end portion is connected to one end of a lead 66, and the other end of the lead 66 is pulled out from between the first laminate material 41 and the second laminate material 42 to the outside of the third battery element chamber 83. The pulled-out portion is served as a positive electrode terminal of the high power battery 2.

As described above, in the high-output batteries 1, 2, and 3, a plurality of battery elements are connected in series by the metal foil of the laminate material which is a case material. Since a plurality of battery elements is connected in one case, it is possible to connect the plurality of battery elements with less space as compared with the case in which respective battery elements are connected outside. This does not cause an increased thickness of the case due to the connection. Therefore, it possible to minimize the enlargement of the planar dimension due to serial connection, and also possible to realize a thin and high power battery. Moreover, since it is thin, it is high in heat dissipation. Furthermore, in the high power battery 2 in which two battery elements are connected, the metal foil exposed portion of the laminate material can be used as a positive electrode terminal or a negative electrode terminal, which can attain further miniaturization by not using leads.

In any one of the above-described high-output batteries 1, 2, and 3, the positions of the positive electrode and the negative electrode of the battery element in the battery element chamber can be reversed, and the forming position of the metal exposed portion can be reversed between the first laminate material of the flat sheet and the second laminate material having the recesses. Further, since the battery element chamber can be produced if an accommodation space can be formed between two laminate materials, formation of a recess by plastic working is not an essential condition. Even with two flat sheet laminate materials or two laminate materials having recesses, a case can be produced.

### (Fourth High Power Battery)

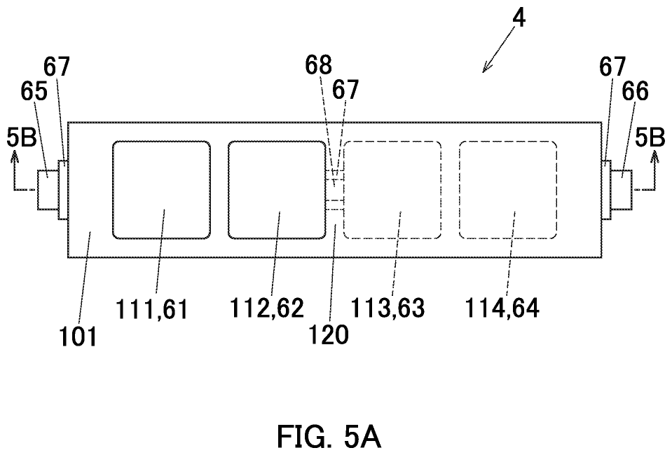

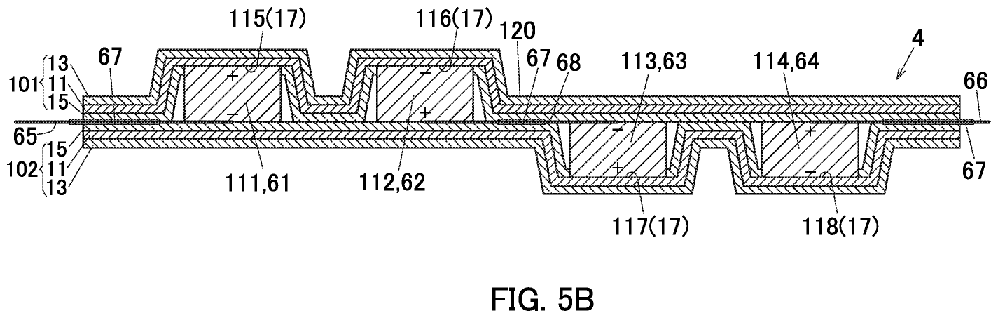

In the above-described high-output batteries 1, 2, and 3, although the number of battery elements is two or three. However, by connecting a lead connected to a battery element to another battery element within a case, it is possible to connect four or more battery elements in series. FIG. 5A and FIG. 5B show a high power battery 4 in which four battery elements are connected in series.

The first laminate material 101 constituting the case of the high power battery 4 is provided with inner metal exposed portions 115 in the first battery element chamber 111 and an inner metal exposed portions 116 in the second battery element chamber 112. The second laminate material 102 is provided with an inner metal exposed portion 117 in the third battery element chamber 113 and an inner metal exposed portion 118 in the fourth battery element chamber 114. The inner metal exposed portions 115, 116, 117, and 118 correspond to the metal exposed portion 17 formed on the surface of the heat fusible resin layer 15 side shown in FIG. 1.

In the first battery element 61 accommodated in the first battery element chamber 111, the positive electrode is in contact with the inner metal exposed portion 115 and electrically connected to the metal foil 11 of the first laminate material 101. In the second battery element 62 accommodated in the second battery element chamber 112, the negative electrode is in contact with the inner metal exposed portion 116 and electrically connected to the metal foil 11 of the first laminate material 101. Further, in the third battery element 63 accommodated in the third battery element chamber 113, the positive electrode is in contact with the inner metal exposed portion 117 and electrically connected to the metal foil 11 of the second laminate material 102. In the second battery element 64 accommodated in the fourth battery element chamber 114, the negative electrode is in contact with the inner metal exposed portion 116 and electrically connected to the metal foil 11 of the second laminate material 102. Furthermore, the positive electrode of the second battery element 62 and the negative electrode of the third battery element 63 are connected via a lead 68. The lead 68 is provided with an insulating resin film 67 bonded on both surfaces of an intermediate portion of the lead. The lead arranged between the first laminate material 101 and the second laminate material 102 of the heat-sealed portion 120 between the second battery element chamber 112 and the third battery element chamber 113. One end of the lead is connected to the positive electrode of the second battery element 62 in the second battery element chamber 112 and the other end thereof is connected to the negative electrode of the third battery element 63 in the third battery element chamber 113. The resin film 67 bonded to the lead 68 enhances the bonding force with the heat fusible resin layers 15 in the same manner as in the resin film 67 bonded to the leads 65 and 66 pulled out of the case. With the above-described configuration, the first to fourth battery elements 61, 62, 63, and 64 are connected in series via the metal foil 11 of the first laminate material 10, the lead 68, and the metal foil 11 of the second laminate material 101.

Further, the negative electrode of the first battery element 61 is connected to one end of a lead 65, and the other end of the lead 65 is pulled out from between the first laminate material 101 and the second laminate material 102 to the outside of the first battery element chamber 111. The pulled-out portion is served as a negative electrode terminal of the high power battery 1. Further, the positive electrode of the fourth battery element 64 is connected to one end of a lead 66, and the other end of the lead 66 is pulled out from between the first laminate material 101 and the second laminate material 102 to the outside of the fourth battery element chamber 114. The pulled-out portion is served as a positive electrode terminal of the high power battery 4.

As described above, by combining the method of connecting battery elements with leads arranged in the case with the method of connecting battery elements of adjacent battery element chambers with a metal foil of a laminate material, it is possible to connect four battery elements in series in the case, which makes it possible to produce a battery with higher output. Further, the lead is placed in the battery element chamber and the heat-sealed portion, which does not increase the battery size by the lead. This makes it possible to connect with less space as compared with the case in which two batteries each having two battery element chambers, such as, the high-output batteries 1 as shown in FIG. 2A and FIG. 2B, are connected by two leads 65 and 66 pulled out of a case. Further, in the same manner as in a high power battery with no leads in the case, since it is thin, it is high in heat dissipation.

In the present invention, a lead connected to a battery element functions as a positive electrode terminal or a negative electrode terminal of the battery when the other end of the lead is pulled out of the case, and functions as a battery element serial connection means in the battery when the other end is connected to another battery element in the case.

Although the number of battery elements of the illustrated example is four, by connecting battery elements accommodated in battery element chambers having no inner metal exposed portion via leads in the case, it is possible to produce a high power battery in which 5 or more battery elements are connected in series. Further, by connecting a battery element accommodated in a battery element chamber having no inner metal exposed portion to the high power battery 3 shown in FIG. 4A and FIG. 4B via a lead, it is possible to increase the number of battery elements.

### EXAMPLES

Two-series high power battery shown in FIG. 2A and FIG. 2B, and three-series high power battery 3 shown in FIG. 4A and FIG. 4B were produced.

### (Laminate Material)

A laminate material used as a a material of a case has a laminate structure shown in FIG. 1. Using the following materials, four kinds of laminate materials including a first laminate material 21 and a second laminate material 22 of a two-series case, and a first laminate material 41 and a second laminate material 42 of a three-series case were produced.

Metal foil 11: electrolytic nickel foil having a thickness of 20 μm

Heat resistant resin layer 13: stretched nylon film having a thickness of 25 μm

Heat fusible resin layer 15: unstretched polypropylene film having a thickness of 30 μm

First adhesive layer 12: two-part curing type polyester-urethane based adhesive agent

Second adhesive layer 14: two-part curing type acid-modified polypropylene based adhesive agent

The first laminate material 21 of the two-series case did not have a metal exposed portion, and a heat resistant resin layer 13 was bonded to one surface of the metal foil 11 with a first adhesive layer 12, and a heat fusible resin layer was bonded to the other surface with a second adhesive layer 14.

The second laminate material 22 of the two-series case, the first laminate material 41 and the second laminate material 42 of the three-series case were laminate materials having metal exposed portions 17 serving as the inner metal exposed portion of the case. In these laminate materials 22, 41, and 42, first, an adhesive agent was applied to form a second adhesive layer 14 while forming adhesive agent unapplied portions in which the adhesive agent was not applied to required positions on one surface of the metal foil 11 using a gravure roll. Thereafter, the metal foil 11 and the heat fusible resin layer 15 were bonded to each other, the first adhesive layer 12 was formed on the other surface, and the heat resistant resin layer 13 was bonded and an aging treatment was performed. Thereafter, the heat fusible resin layer 15 was cut with a laser along the outline of the adhesive uncoated portion, and the metal exposed portion 17 was formed by removing the resin layer piece.

Further, in the second laminate material 22, 42, recesses in which the heat fusible resin layer 15 side was recessed were formed by drawing. The recess is 40 mm long×40 mm wide×4 mm deep (height).

### (Battery Element)

A bare cell was produced using the following positive electrode, negative electrode, and separator.

### Positive Electrode:

A binder solution prepared by dissolving PVDF (polyvinylidene difluoride) as a binder in a solvent (dimethylformamide) was applied to one surface of a hard aluminum foil (A1100 hard aluminum foil classified in JIS H4160) having a width of 500 mm and a thickness of 15 μm, and then dried at 100° C. for 30 seconds to form a binder layer having a thickness of 0.5 μm after drying. Next, a paste in which 60 parts by mass of a positive electrode active material containing lithium cobalt oxide as a main component, 10 parts by mass of PVDF (polyvinylidene difluoride) as a binder/electrolyte retention agent, 5 parts by mass of acetylene black (conductive material), and 25 parts by mass of N-methyl-2-pyrrolidone (NMP) (organic solvent) was kneaded and dispersed was applied to the surface of the binder layer, followed by drying at 100° C. for 30 minutes. Then, by performing hot pressing, a positive electrode active material layer having a density of 4.8 g/cm³ and a thickness after drying of 120 μm was formed and cut to a width of 35 mm. Thus, a positive electrode was obtained.

### Negative Electrode:

Next, a binder solution prepared by dissolving PVDF (polyvinylidene difluoride) as a binder in a solvent (dimethylformamide) was applied to one surface of a hard copper foil (C1100R classified in JIS H3100) having a width of 500 mm and a thickness of 15 μm, and then dried at 100° C. for 30 seconds to form a binder layer having a thickness of 0.5 μm after drying. Next, a paste in which 57 parts by mass of a negative electrode active material containing carbon powder as a main component, 5 parts by mass of PVDF as a binder/electrolyte retention agent, 10 parts by mass of copolymer of hexafluoro propylene and maleic anhydride, 3 parts by mass of acetylene black (conductive material), and 25 parts by mass of N-methyl-2-pyrrolidone (NMP) (organic solvent) was kneaded and dispersed was applied to the surface of the binder layer, followed by drying at 100° C. for 30 minutes. Then, by performing hot pressing, a positive electrode active material layer having a density of 1.5 g/cm³ and a thickness after drying of 20.1 μm was formed and cut to a width of 35 mm. Thus, a negative electrode was obtained.

### Separator:

A porous wet separator having a width of 38 mm and a thickness of 8 μm was used.

A laminate in which the above materials were laminated in the order of a negative electrode (negative electrode active material layer side is arranged on the separator a side)/separator a/positive electrode (disposed on separator b is arranged on the separator b/separator b) while shifting the longitudinal end portion was wound to form a 38 mm square bare cell (38 mm×38 mm square shape in a plan view) having a thickness of 4 mm in which a hard aluminum foil serving as a positive electrode was exposed to one surface and a hard copper foil serving as a negative electrode was exposed to the other side. The bare cell was used as a first bare cell 61a, a second bare cell 62a, and a third bare cell 63a.

### Electrolyte:

An electrolyte in which lithium hexafluorophosphate (LiPF₆) was dissolved by a concentration of 1 mol/L in a mixed solvent in which ethylene carbonate (EC), dimethyl carbonate (DMC), and ethyl methyl carbonate (EMC) were mixed in equal volumetric ratio was used.

### (Two-Series High Power Battery: See FIG. 2A and FIG. 2B)

The plane dimension of the high power battery 1 was 60 mm×110 mm, and the first battery element chamber 51 and the second battery element chamber 52 were 40 mm in length×40 mm in width×4 mm in depth, respectively. The heat-sealed portion had a width of 10 mm.

The first laminate material 21 constituting the case was a flat sheet having no metal exposed portion, and the second laminate material 22 had two recesses serving as the first battery element chamber 51 and the second battery element chamber 52, and each had an inner metal exposed portion 25, 26 at the bottom of the inner surface.

Of the two bare cells, a negative electrode lead 65 made of a copper foil having a width of 5 mm, a length of 50 mm, and a thickness of 100 μm was bonded to a negative electrode of the first bare cell 61a, and a positive electrode lead 66 made of a soft aluminum foil having a width of 5 mm, a length of 50 mm, and a thickness of 100 μm was bonded to a positive electrode of the second bare cell 62a.

The first bare cell 61a was loaded in the recess serving as the first battery element chamber 51 of the second laminate material 22 with the positive electrode facing downward, and the positive electrode was brought into contact with the inner metal exposed portion 25. Further, the second bare cell 62a was loaded in the recess serving as the second battery element chamber 52 with the negative electrode facing downward, and the negative electrode was brought into contact with the inner metal exposed portion 26. The other end of the negative electrode lead 65 and the other end of the positive electrode lead 66 were pulled out from both ends (short sides) of the second laminate material 22 in the longitudinal direction, and covered by the first laminate material 21 to close the opening of the first battery element chamber 51 and the second battery element chamber 52.

Next, two short sides from which the negative electrode lead 65 and the positive electrode lead 66 were pulled out, between the first battery element chamber 51 and the second battery element chamber 52, one long side were heat-sealed. Heat sealing was carried out by clamping with a pair of hot plates at 200° C. from above and below the sealing side at a pressure of 0.3 MPa and holding for 3 seconds. By the heat sealing, only one side of the first battery element chamber 51 and the second battery element chamber 52 were unsealed. Then, 5 mL of electrolyte was injected from the unsealed side of each of the first battery element chamber 51 and the second battery element chamber 52 with a liquid injection syringe. Next, the unsealed side was temporarily fixed by clipping it, lead wires were connected to the negative electrode lead 65 and the positive electrode lead 66. Charging was performed until a cell voltage of 8.2 V was generated between them so that gas was evacuated from the electrode, separator, etc. Thereafter, in a state of the discharge condition of 6.0 V and under the reduced pressure of 0.086 MPa, the unsealed side was sandwiched by a pair of hot plates at 200° C. from above and below at a pressure of 0.3 MPa and held for 3 seconds to thereby be completely sealed and bonded. With this, a high power battery 1 with a battery capacity of 1160 mAh having the configuration shown in FIG. 2A and FIG. 2B was obtained.

Three high-output batteries 1 were produced using the same material by the same method.

### (Three-Series High Power Battery: See FIG. 4A and FIG. 4B)

The plane dimension of the high power battery 3 was 60 mm×160 mm, and the first to third battery element chambers 81, 82, and 83 were 40 mm in length×40 mm in width×4 mm in depth, respectively. The heat-sealed portion was 10 mm in width.

The first laminate material 41 constituting the case is a flat sheet and has an inner metal exposed portion 43, 44 in each of the second battery element chamber 82 and the third battery element chamber 83. Also, the second laminate material 42 has three recesses serving as the first to third battery element chambers 81, 82, 83, and also has the inner metal exposed portions 45, 46 at the bottom of the inner surface of the first battery element chamber 81 and the second battery element chamber 82.

Of the three bare cells, a negative electrode lead 65 made of a copper foil having a width of 5 mm, a length of 50 mm, and a thickness of 100 μm was joined to the negative electrode of the first bare cell 61a, and a positive electrode lead 66 made of a soft aluminum foil having a width of 5 mm, a length of 50 mm, and a thickness of 100 μm was joined to the positive electrode of the third bare cell 63a. A lead was not bonded to the second bare cell 62a.

The first bare cell 61a was loaded in the recess serving as the first battery element chamber 81 of the second laminate material 42 with the positive electrode facing downward, and the positive electrode was brought into contact with the inner metal exposed portion 45. Further, the second bare cell 62a with no lead was loaded in the recess serving as the second battery element chamber 82 with the negative electrode facing downward, and the negative electrode was brought into contact with the inner metal exposed portion 46. The third bare cell 63a was loaded in the recess serving as the third battery element chamber 83 with the positive electrode facing down. The other end of the negative electrode lead 65 and the other end of the positive electrode lead 66 were pulled out from both ends (short sides) of the second laminate material 42 in the longitudinal direction, and covered by the first laminate material 41 to close the opening of the first to third battery element chambers 81, 82, 83. By covering the first laminate material 41, the positive electrode of the second bare cell 62a came into contact with the inner metal exposed portion 43 of the first laminate material 41, and the negative electrode of the third bare cell 63a came into contact with the inner metal exposed portion 44 of the first laminate material 41.

Next, two short sides from which the negative electrode lead 65 and the positive electrode lead 66 were pulled out, between the first battery element chamber 81 and the second battery element chamber 82, between the second battery element chamber 82 and the third battery element chamber 83, and one long side were heat-sealed. By the heat sealing, only one side of the first to third battery element chambers 81, 82, 83 were unsealed. Then, 5 mL of electrolyte was injected from the unsealed side of the first to third battery element chambers 81, 82, 83 with a liquid injection syringe. Next, the unsealed side was temporarily fixed by clipping it, lead wires were connected to the negative electrode lead 65 and the positive electrode lead 66. Charging was performed until a cell voltage of 12.5 V was generated between them so that gas was evacuated from the electrode, separator, etc. Thereafter, a state of the discharge condition of 9.0 V and under the reduced pressure of 0.086 MPa, the unsealed side was heat-sealed by the same method for the two-series battery. With this, a high power battery 3 having the configuration shown in FIG. 4A and FIG. 4B and having a battery capacity of 1,720 mAh was obtained.

Three high-output batterie 3 were produced using the same material by the same method.

The produced two kinds of three high-output batteries 1 and 3 were charged, and the initial voltage after charging was measured. The measured values are shown in Table 1.

TABLE 1

| | Voltage (V) | | | |
|---|---|---|---|---|
| | 1 | 2 | 3 | Average |
| Two-series high power battery | 8.6 | 8.4 | 8.5 | 8.5 |
| Three-series high power battery | 12.5 | 12.8 | 12.7 | 12.7 |

From Table 1, it was confirmed that a desired voltage was obtained.

The present application claims priority to Japanese Patent Application No. 2016-225813 filed on Nov. 21, 2016, the entire disclosure of which is incorporated herein by reference in its entirety.

It should be understood that the terms and expressions used herein are used for explanation and have no intention to be used to construe in a limited manner, do not eliminate any equivalents of features shown and mentioned herein, and allow various modifications falling within the claimed scope of the present invention.

### INDUSTRIAL APPLICABILITY

The high power battery of the present invention can be suitably used as various power supplies.

### DESCRIPTION OF REFERENCE SYMBOLS

1, 2, 3, 4: high power battery
10: laminate material
11: metal foil
13: heat resistant resin layer
15: heat fusible resin layer
16, 17: metal exposed portion
21, 31, 41, 101: first laminate material
22, 42, 102: second laminate material
51,71, 81, 111: first battery element chamber
52, 72, 82, 112: second battery element chamber
83, 113: third battery element chamber
114: forth battery element chamber
25, 26, 35, 43, 44, 45, 46, 115, 116, 117, 118: inner metal exposed portion
36: outer metal exposed portion
61: first battery element
62: second battery element
63: third battery element
64: fourth battery element
65: lead (negative electrode lead)
66: lead (positive electrode lead)
67: lead

1. A high power battery comprising:
a case having two battery element chambers formed by being surrounded by a heat-sealed portion formed by arranging two laminate materials in which a heat resistant resin layer laminated on one surface of a metal foil and a heat fusible resin layer is laminated on the other surface of the metal foil with the heat fusible resin layers facing inward and fusing the heat fusible resin layers; and
two battery elements accommodated in respective battery element chambers of the case,
wherein one of the laminate materials of the case is provided with inner metal exposed portions through which a part of the metal foil is exposed in the respective battery element chambers,
wherein the two battery elements are connected in series via the inner metal exposed portions of the one of the laminate materials in the respective battery element chambers and the metal foil of the one of the laminate materials, and
wherein in each of the two battery elements, a positive electrode or a negative electrode of one of the two battery elements which is not connected to the other of the two battery elements is connected to one end of a lead.

2. A high power battery comprising:
a case having two battery element chambers formed by being surrounded by a heat-sealed portion formed by arranging two laminate materials in which a heat resistant resin layer is laminated on one surface of a metal foil and a heat fusible resin layer is laminated on the other surface of the metal foil with the heat fusible resin layers facing inward and fusing the heat fusible resin layers; and
two battery elements accommodated in respective battery element chambers of the case,
wherein in the case, one of the laminate materials is provided with inner metal exposed portions through which a part of the metal foil is exposed in the respective battery element chambers,
wherein the two battery elements are connected in series via the inner metal exposed portions of the one of the laminate materials in the respective battery element chambers and the metal foil of the one of the laminate materials,
wherein a positive electrode or a negative electrode of one of the battery elements which is not connected to the other of the battery elements is connected to one end of a lead, and the other end of the lead is pulled out of the case from between the heat fusible resin layers of the laminate materials, and
wherein a negative electrode or a positive electrode of the one of the battery elements which is not connected to the other of the battery elements is electrically connected to an inner metal exposed portion through which a part of the metal foil of the other of the laminate materials is exposed in the battery element chamber, and the other of the laminate materials is provided with an outer metal exposed portion through which a part of the metal foil is exposed outside the battery element chamber.

3. A battery case comprising:
two battery element chambers formed by being surrounded by a heat-sealed portion formed by arranging two laminate materials in which a heat resistant resin layer is laminated on one surface of a metal foil and a heat fusible resin layer is laminated on the other surface of the metal foil with the heat fusible resin layers facing inward and fusing the heat fusible resin layers,
wherein one of the laminate materials of the case is provided with inner metal exposed portions through which a part of the metal foil is exposed in respective battery element chambers, and
wherein the other of the laminate materials is provided with an inner metal exposed portion through which a part of the metal foil is exposed in one of the battery element chambers and an outer metal exposed portion through which a part of the metal foil is exposed to an outer surface of the case.

4. A high power battery comprising:
a case having three battery element chambers including first to third battery element chambers formed by being surrounded by a heat-sealed portion formed by arranging two laminate materials in which a heat resistant resin layer is laminated on one surface of a metal foil and a heat fusible resin layer is laminated on the other surface of the metal foil with the heat fusible resin layers facing inward and fusing the heat fusible resin layers; and
three battery elements accommodated in respective battery element chambers of the case,
wherein in the case, the two laminate materials are each provided with an inner metal exposed portion through which apart of a metal foil is exposed in the second battery element chamber, one of the laminate materials is provided with an inner exposed portion through which a part of the metal foil is exposed in the first battery element chamber, and the other of the laminate materials is provided with an inner exposed portion through which a part of the metal foil is exposed in the third battery element chamber,
wherein the first battery element accommodated in the first battery element chamber and the second battery element accommodated in the second battery element chamber are connected in series via the inner metal exposed portions of the one of the laminate materials and the metal foil thereof, and the second battery element accommodated in the second battery element chamber and the third battery element accommodated in the third battery element chamber are connected in series via the inner metal exposed portions of the other of the laminate materials and the metal foil thereof, and
wherein a positive electrode or a negative electrode of the first battery element which is not connected to the second battery element is connected to one end of a lead, and a negative electrode or a positive electrode of the third battery element which is not connected to the second battery element is connected to one end of a lead.

5. A battery case comprising:
three battery element chambers including first to third battery element chambers formed by being surrounded by a heat sealed portion formed by arranging two laminate materials in which a heat resistant resin layer is laminated on one surface of a metal foil and a heat fusible resin layer is laminated on the other surface of the metal foil with the heat fusible resin layers facing inward and fusing the heat fusible resin layers,
wherein in the second battery element chamber, the two laminate materials are each provided with an inner metal exposed portion through which a part of the metal foil is exposed,
wherein in the first battery element chamber, one of the laminate materials is provided with an inner metal exposed portion through which a part of the metal foil is exposed, and
wherein in the third battery element chamber, the other of the laminate materials is provided with an inner metal exposed portion through which a part of the metal foil is exposed.

6. A high power battery comprising:
a case having four battery element chambers including first to fourth battery element chambers formed by being surrounded by a heat-sealed portion formed by arranging two laminate materials in which a heat resistant resin layer is laminated on one surface of a metal foil and a heat fusible resin layer is laminated on the other surface of the metal foil with the heat fusible resin layers facing inward and fusing the heat fusible resin layers; and
four battery elements accommodated in respective battery element chambers of the case,
wherein in the case, one of the laminate materials is provided with an inner metal exposed portion through which a part of the metal foil is exposed in the first battery element chamber and an inner metal exposed portion through which a part of the metal foil is exposed in the second battery element chamber, and the other of the laminate materials is provided with an inner metal exposed portion through which a part of the metal foil is exposed the third battery element chamber and an inner metal exposed portion through which a part of the metal foil is exposed in the fourth battery element chamber,
wherein a first battery element accommodated in the first battery element chamber and a second battery element accommodated in the second battery element chamber are connected in series via the inner metal exposed portions of the one of the laminate materials and the metal foil thereof,
wherein a third battery element accommodated in the third battery element chamber and a fourth battery element accommodated in the fourth battery element chamber are connected in series via the inner metal exposed portions of the other of the laminate material and the metal foil thereof,
wherein a lead is arranged between the first laminate materials and the second laminate material of the heat-sealed portion between the second battery element chamber and the third battery element chamber, one end of the lead is connected to a negative electrode or a positive electrode of the second battery element in the second battery element chamber which is not connected to the first battery element, the other end of the lead is connected to a negative electrode or a positive electrode of the third battery element in the third battery element chamber which is not connected to the fourth battery element, so that the third battery element and the third battery element are connected in series via the lead, and
wherein a positive electrode or a negative electrode of the first battery element which is not connected to second battery element is connected to one end of a lead, and a negative electrode or a positive electrode of the fourth battery element which is not connected to the third battery element is connected to one end of a lead.
